(19) United States
(12) Patent Application Publication
(10) Pub. No.: US 2026/0059564 A1
(43) Pub. Date: Feb. 26, 2026

(54) POWER-OPTIMIZATION FOR RANGING OPERATIONS

(71) Applicant: QUALCOMM Incorporated, San Diego, CA (US)

(72) Inventors: Shivraj Singh Sandhu, Milpitas, CA (US); Alireza Raissinia, Monte Sereno, CA (US)

(21) Appl. No.: 19/265,951

(22) Filed: Jul. 10, 2025

Related U.S. Application Data
(60) Provisional application No. 63/685,604, filed on Aug. 21, 2024.

(51) Int. Cl. H04W 72/51; H04W 64/00; H04W 72/0453; H04W 76/10

(52) U.S. Cl. CPC H04W 72/51; H04W 64/00; H04W 72/0453; H04W 76/10

(57) ABSTRACT

Techniques for power-optimized ranging in wireless communication. A device transmits a frame on a channel and obtains a response from a wireless node. The device then performs a ranging capability exchange, sharing ranging attributes with the wireless node. Based on this exchange, the device negotiates a ranging channel. It defines an availability window with a fixed duration for ranging sessions and selects a nominal rate for the window's cadence based on application needs. The device communicates these parameters to the wireless node, enabling power-saving between windows. During availability windows, the device conducts ranging measurements and can request parameter renegotiation using a designated field.

### PRIORITY

This application claims the benefit of U.S. Provisional Patent Application No. 63/685,604, filed on Aug. 21, 2024, entitled “POWER-OPTIMIZATION FOR RANGING OPERATIONS,” the entire disclosure of which is hereby incorporated by reference.

### TECHNICAL FIELD

This disclosure generally relates to wireless communication, and more specifically, to power-optimized peer-to-peer ranging techniques with dynamic availability scheduling.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

Wireless communication technologies have evolved to support a wide range of applications and services. Among them, peer-to-peer (P2P) communications, which enable direct device-to-device interactions without the need for traditional network infrastructure, have gained traction.

Ranging techniques are used in P2P communications to determine the relative positions of devices. Ranging typically involves measuring the time-of-flight of signals between devices to estimate their relative distances. This capability is valuable in various applications, including indoor navigation, asset tracking, and proximity-based services.

However, implementing ranging features in P2P communications presents unique challenges concerning power consumption and device availability. According to current P2P ranging protocols, devices often need to maintain a high level of availability to respond to ranging requests from peer devices. This requirement can lead to significant power drain for battery-operated devices that need to remain in an active state for extended periods. And the power consumption issue is exacerbated in scenarios where ranging needs vary according to specific applications running on the devices.

Moreover, the integration of ranging capabilities with other networking features, such as Neighbor Awareness Networking (NAN), introduces additional complexities. NAN allows devices to discover and communicate with nearby peers efficiently—but coordinating NAN operations with ranging activities can be challenging—especially in unsynchronized environments.

Existing solutions have not adequately addressed the balance between maintaining ranging accuracy and optimizing power consumption in P2P communications. As such, there is a need for adaptive ranging techniques that align with the diverse needs of applications while minimizing energy usage. Improved ranging techniques that offer power efficiency, adaptability, and seamless integration with other networking features are necessary to improve wireless devices and applications.

### SUMMARY

The systems, methods and devices of this disclosure each have several innovative aspects, no single one of which is solely responsible for the desirable attributes disclosed herein.

One innovative aspect of the subject matter described in this disclosure can be implemented in a first apparatus for wireless communication. The first apparatus includes a processing system configured to cause the first apparatus to output, for transmission on a discovery channel, a frame, obtain a response associated with the frame from a wireless node, perform a ranging capability exchange with the wireless node, and negotiate a ranging channel with the wireless node according to the exchanged ranging capability.

In some implementations, the ranging capability exchange includes exchanging one or more ranging attributes comprising at least one of a Location Information Availability field, a Ranging Protocol Type field, or a Ranging Band Information field. The first apparatus may output an SDF follow-up to indicate staying on the discovery channel for another exchange. It may operate as at least one of an initiating station (ISTA) or a responding station (RSTA) for a ranging operation according to at least one of a service type or a subscriber status. The first apparatus may also establish a data channel with the wireless node after the ranging channel negotiation and perform a Pre-Association Security Negotiation (PASN) with the wireless node via the data channel.

In some examples, the Ranging Information attribute further includes at least one of a Last Movement Indication field, a 2.4 GHz Ranging Channel ID field, a 5 GHZ Ranging Channel ID field, or a 6 GHz Ranging Channel ID field. The first apparatus may obtain channel availability for a subsequent ranging operation according to the exchanged Ranging Information attribute. The Location Information Availability field may indicate availability of local coordinates, geospatial location information, civic location information, or last movement indication. The Ranging Protocol Type field may indicate support for 802.11 Rev mc protocol ranging or Proximity NTB ranging. The Ranging Band Information field may indicate availability of 2.4 GHz, 5 GHZ, or 6 GHz Ranging Channels.

Another innovative aspect of the subject matter described in this disclosure can be implemented in a first apparatus for wireless communication. The first apparatus includes a processing system configured to cause the first apparatus to select an availability window having a duration for a ranging measurement exchange, select a nominal rate associated with the availability window based on one or more applications running on the first apparatus, and output an indication of the nominal rate for transmission to a wireless node. The selection of at least one of the availability window or the nominal rate enables a low power state between consecutive availability windows.

In some implementations, the first apparatus may obtain a request to re-negotiate the nominal rate from the wireless node and re-negotiate the nominal rate. It may obtain a ranging measurement request from the wireless node during the availability window, perform one or more ranging measurements, and output a location measurement report (LMR) including the results. The LMR may include an indication that re-negotiation of the nominal rate is possible, such as by setting a bit in a Time of Arrival (TOA) Error field.

In some examples, the first apparatus may exchange ranging attributes with the wireless node during an unsynchronized discovery phase, including a Ranging Information attribute comprising support for at least one of an ISTA role and an RSTA role. It may negotiate a ranging channel with the wireless node during a service discovery phase. The nominal rate may be associated with a cadence of the availability window for an RSTA device, and the first apparatus may use a maximum time field to indicate the nominal rate.

Another innovative aspect of the subject matter described in this disclosure can be implemented in a first apparatus for wireless communication. The first apparatus includes a processing system configured to cause the first apparatus to select an availability window having a duration for a ranging measurement operation, select a nominal rate associated with the availability window based on one or more applications running on the first apparatus, perform one or more ranging measurements during the availability window, and generate a location measurement report (LMR) including at least one of a result of the measurements or one or more updated parameters for the ranging measurement operation.

In some implementations, the first apparatus may output the LMR for transmission to a wireless node and apply the one or more updated parameters in the availability window. The updated parameters may be based on an application need of the first apparatus. The first apparatus may operate as at least one of an ISTA or an RSTA for the ranging measurement operation and output the LMR regardless of its operational role.

In some examples, the first apparatus may adjust the nominal rate during the ranging measurement operation based on the one or more updated parameters. It may set a bit in a Time of Arrival (TOA) Error field of the LMR to indicate a need for parameter update. The ranging measurement operation may span one or more availability windows, and the first apparatus may apply the one or more updated parameters during these windows. The first apparatus may also negotiate the updated parameters with the wireless node during the ranging measurement operation without interrupting an ongoing ranging measurement.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network 100.

FIG. 2 shows a timing diagram illustrating an example process for performing a ranging operation.

FIG. 3 shows a pictorial diagram of another example wireless communication network 300.

FIG. 4 shows a flowchart illustrating an example process 400 performable by or at a first apparatus for wireless communication that supports peer-to-peer ranging, including steps for outputting a frame, obtaining a response, performing a ranging capability exchange, and negotiating a ranging channel.

FIG. 5 shows a block diagram of an example wireless communication device 500 that supports peer-to-peer ranging, including components for frame output, response processing, ranging capability exchange, and ranging channel negotiation.

FIG. 6 illustrates a flowchart of an example process 600 performable by or at a wireless station that supports power-optimized peer-to-peer ranging as an initiating station (ISTA), including steps for selecting an availability window and nominal rate, and outputting an indication of the nominal rate.

FIG. 7 illustrates a block diagram of an example wireless communication device 700 that supports power-optimized peer-to-peer ranging as an initiating station (ISTA), including components for availability window and nominal rate selection, transmission, and power management.

FIG. 8 shows a flowchart illustrating an example process 800 performable by or at a wireless station that supports power-optimized peer-to-peer ranging, including steps for selecting an availability window and nominal rate, performing ranging measurements, and generating a location measurement report (LMR).

FIG. 9 illustrates a block diagram of an example wireless communication device 900 that supports power-optimized peer-to-peer ranging, including components for availability window and nominal rate selection, ranging measurement, LMR generation, and LMR transmission.

FIG. 10 is a signaling diagram illustrating an example process 1000 that supports peer-to-peer (P2P) ranging communication between an initiator device 1002 and a responder device 1004, showing the Unsynchronized Service Discovery (USD) stage, Pre-Association Features stage, and Pairing/Datapath stage.

FIG. 11 illustrates a timeline 1100 for power-optimized peer-to-peer (P2P) ranging, showing the relationship between various timing parameters and the structure of availability windows, including Min time, Nominal rate, and Max time.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, peer-to-peer (P2P) ranging techniques are employed to determine the relative positions of devices without relying on traditional network infrastructure. These techniques typically involve measuring the time-of-flight of signals between devices to estimate their distances. However, implementing efficient P2P ranging in mobile devices presents significant challenges, particularly in terms of power consumption and device availability. Devices often need to remain in an active state for extended periods to respond to ranging requests, which can quickly deplete battery life. Moreover, the integration of ranging capabilities with other networking features introduces additional complexities, especially in unsynchronized environments where devices may not have a common time reference. The varying needs of different applications further complicate the situation, as some may require frequent ranging updates while others can operate with less frequent position information.

In view of the foregoing, the present disclosure relates to power-optimized peer-to-peer (P2P) ranging techniques for wireless communication devices, particularly in unsynchronized discovery scenarios. Described techniques introduce efficient device discovery, capability exchange, and adaptive ranging operations that balance power consumption with application needs.

An aspect involves a mechanism for ranging-capable devices to discover each other and exchange capability information efficiently. Devices transmit and receive frames on a discovery channel followed by a ranging capability exchange. The exchange includes sharing one or more ranging attributes containing fields such as Location Information Availability, Ranging Protocol Type, and Ranging Band Information. Subsequently, devices can negotiate a suitable ranging channel based on their shared capabilities.

To ensure secure communication, a Pre-Association Security Negotiation (PASN) process is performed based on the exchanged ranging capability. This negotiation establishes a secure foundation for subsequent ranging operations, and can occur before or during the establishment of a full data channel with the wireless node

Power optimization in ranging operations is addressed through the introduction of availability windows with durations for ranging measurement exchanges. Devices can select a nominal rate for the windows based on the requirements of their running applications. By communicating this nominal rate to peer devices, a device can conserve energy by entering a low-power state between availability windows while maintaining ranging functionality.

Adaptability is enabled through dynamic updates to ranging parameters. Devices can generate and transmit Location Measurement Reports (LMRs) that include ranging measurement results and indicate the need for parameter updates. These updates may involve changes to the nominal rate, availability window duration, or the number of measurements to be performed in each window.

For efficient re-negotiation of parameters, a specific bit in the Time of Arrival (TOA) Error field of the LMR can be utilized. When set, this bit signals a need for re-negotiation of the nominal rate, thereby allowing devices to adapt their ranging behavior without complex signaling protocols.

The operational roles of devices in ranging operations are also addressed. Devices can operate as either an initiating station (ISTA) or a responding station (RSTA) based on factors such as service type or subscriber role. This flexibility enables more dynamic and adaptable P2P ranging operations. Also, devices can apply updated parameters during ongoing ranging measurement operations. This adaptive approach allows devices to respond to changing application needs or network conditions without interrupting ongoing ranging operations.

Particular advantages arise from, e.g., an efficient discovery and capability exchange mechanism using frames transmitted on a discovery channel and a comprehensive ranging capability exchange that enables rapid establishment of compatible ranging parameters between peer devices. As a result, setup time is reduced and unnecessary ranging attempts between incompatible devices are minimized, leading to more efficient use of network resources and device power.

Enhanced security in ranging operations is further achieved through the Pre-Association Security Negotiation (PASN) process. Performing PASN based on the exchanged ranging capability establishes mutual authentication and encryption keys for ranging operations.

The adaptive parameter update mechanism, facilitated through Location Measurement Reports, offers enhanced flexibility in responding to changing conditions or application requirements. Devices can optimize their ranging behavior in real-time, effectively balancing the trade-off between ranging accuracy, frequency, and power consumption as needed. Also, significant power savings are realized through the implementation of availability windows with a selectable nominal rate. Devices can enter low-power states between ranging sessions while maintaining effective ranging capabilities to extend battery life without compromising functionality.

Utilizing a specific bit in the TOA Error field (or an equivalent or similar structure) of the LMR for indicating re-negotiation needs provides a standardized and efficient method for adapting to changing conditions. Devices can dynamically adjust their ranging frequency without complex signaling protocols such that responsiveness to varying application requirements and network conditions is improved.

Network versatility is improved through support for both initiating station (ISTA) and responding station (RSTA) roles in devices. Such dual-role capability enables dynamic and adaptable P2P networks by allowing devices to switch between initiating and responding roles based on factors such as service type or subscriber roles. Consequently, ranging operations become more robust across diverse scenarios.

The ability to apply updated parameters during ongoing ranging operations ensures continuous and efficient ranging performance. This minimizes disruptions to ranging services while allowing devices to respond to changing needs or conditions, enhancing the overall user experience and reliability of P2P ranging applications.

Integrating ranging capability exchange during the discovery phase streamlines the overall ranging process. Early establishment of ranging capabilities and subsequent negotiation of the ranging channel reduces overhead in subsequent ranging sessions, potentially decreasing latency and improving overall ranging efficiency in P2P communications.

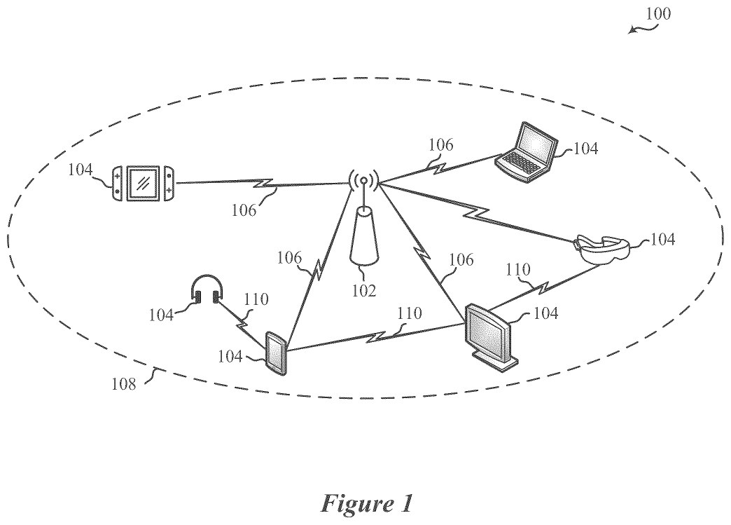

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHZ, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHZ), FR3 (7.125 GHz-24.25 GHZ), FR4a or FR4-1 (52.6 GHz-71 GHZ), FR4 (52.6 GHz-114.25 GHZ), and FR5 (114.25 GHZ-300 GHZ).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

APs and STAs (for example, the AP 102 and the STAs 104 described with reference to FIG. 1) that include multiple antennas may support various diversity schemes. For example, spatial diversity may be used by one or both of a transmitting device (such as either AP 102 or STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally or alternatively involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHZ, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHZ band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MH2) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of the wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

FIG. 1 shows a frequency diagram 100 depicting an example distributed tone mapping. More specifically, FIG. 1 shows an example mapping of how the tones of a payload 101 of a PPDU 102 are distributed for transmission over a spreading bandwidth of a wireless channel. In the illustrated example, the tones in a logical RU 104 (which may represent an rRU of non-distributed tones in accordance with a legacy tone plan) associated with payload 101 are mapped to a distributed RU (dRU) 106 in accordance with a distributed tone plan.

Aspects of the present disclosure recognize that by distributing the tones across a wider bandwidth, the per-tone transmit power of a logical RU 104 may be increased to provide greater flexibility in medium utilization for PSD-limited wireless channels. For example, when mapped to an rRU such as logical RU 104, the transmit power of the logical RU 104 may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 104 is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 102, without exceeding the PSD limits of the wireless channel. As shown in the example of FIG. 1, the STA 104 may map logical RU 104 to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 1 effectively reduces the number of tones (of the logical RU 104) in each 1 MHz subchannel. For example, each of the 26 tones can be mapped to a different 1 MHz subchannel of the 40 MHz channel. As a result, each AP 102 or STA 104 implementing the distributed tone mapping of FIG. 1 can maximize its per-tone transmit power (which may maximize the overall transmit power of the logical RU 104).

In some examples (not shown in FIG. 1), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 102 is transmitted on tones spanning an rRU, such as logical RU 104 (according to a legacy tone plan), or a dRU 106 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some examples, the trigger frame may be further configured to carry tone distribution information indicating whether the logical RU (or MRU) maps to a rRU or a dRU.

In some implementations, a STA 104 may include a distributed tone mapper that maps the logical RU 104 to the dRU 106 in the frequency domain. The dRU 106 is then converted to a time-domain signal (such as by an inverse fast Fourier transform (IFFT)) for transmission over a wireless channel. The AP 102 may receive the time-domain signal and reconstruct the dRU 106 (such as by a fast Fourier transform (FFT)). In some implementations, the AP 102 may include a distributed tone demapper that demaps the dRU 106 to the logical RU 104. In other words, the distributed tone demapper reverses the mapping performed by the distributed tone mapper at the STA 104. The AP 102 can recover the information carried (or modulated) on the logical RU 104 as a result of the demapping.

In the example of FIG. 1, the logical RU 104 is distributed evenly across the spreading bandwidth. While the example shown in FIG. 1 illustrates a spreading bandwidth of 40 MHz, spreading bandwidths also may include 80 MHz, 160 MHz, or 320 MHz. In some implementations, the logical RU 104 can be mapped to any suitable pattern of noncontiguous subcarrier indices. For example, in various implementations, the distance between any pair of adjacent modulated tones may be less than or greater than the distances depicted in FIG. 1.

Aspects of transmissions may vary according to a distance between a transmitter (for example, an AP 102 or a STA 104) and a receiver (for example, another AP 102 or STA 104). Wireless communication devices (such as the AP 102 or the STA 104) may generally benefit from having information regarding the location or proximities of the various STAs 104 within the coverage area. In some examples, relevant distances may be determined (for example, calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

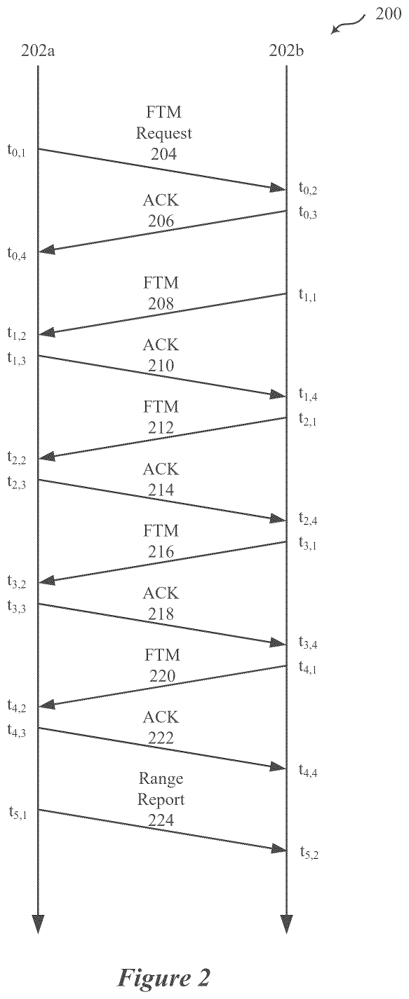

FIG. 2 shows a timing diagram illustrating an example process for performing a ranging operation. The process for the ranging operation 200 may be conjunctively performed by two wireless communication devices, such as a first wireless communication device 202a and a second wireless communication device 202b, in accordance with the IEEE 802.11REVme standards, which may each be an example of an AP 102 or a STA 104.

The ranging operation 200 may begin with the first wireless communication device 202a transmitting an initial FTM range request frame 204 at time t0,1. Responsive to successfully receiving the FTM range request frame 204 at time t0,2, the second wireless communication device 202b responds by transmitting a first ACK 206 at time t0,3, which the first wireless communication device 202a receives at time t0,4. The first wireless communication device 202a and the second wireless communication device 202b exchange one or more FTM bursts, which may each include multiple exchanges of FTM action frames (hereinafter simply “FTM frames”) and corresponding ACKs. One or more of the FTM range request frame 204 and the FTM action frames (hereinafter simply “FTM frames”) may include FTM parameters specifying various characteristics of the ranging operation 200.

In the example shown in FIG. 2, in a first exchange, beginning at time t1,1, the second wireless communication device 202b transmits a first FTM frame 208. The second wireless communication device 202b records the time t1,1 as the time of departure (TOD) of the first FTM frame 208. The first wireless communication device 202a receives the first FTM frame 208 at time t1,2 and transmits a first acknowledgment frame (ACK) 210 to the second wireless communication device 202b at time t1,3. The first wireless communication device 202a records the time t1,2 as the time of arrival (TOA) of the first FTM frame 208, and the time t1,3 as the TOD of the first ACK 210. The second wireless communication device 202b receives the first ACK 210 at time t1,4 and records the time t1,4 as the TOA of the first ACK 210.

Similarly, in a second exchange, beginning at time t2,1, the second wireless communication device 202b transmits a second FTM frame 212. The second FTM frame 212 includes a first field indicating the TOD of the first FTM frame 208 and a second field indicating the TOA of the first ACK 210. The first wireless communication device 202a receives the second FTM frame 212 at time t2,2 and transmits a second ACK 214 to the second wireless communication device 202b at time t2,3. The second wireless communication device 202b receives the second ACK 214 at time t2,4. Similarly, in a third exchange, beginning at time t3,1, the second wireless communication device 202b transmits a third FTM frame 216. The third FTM frame 216 includes a first field indicating the TOD of the second FTM frame 212 and a second field indicating the TOA of the second ACK 214. The first wireless communication device 202a receives the third FTM frame 216 at time t3,2 and transmits a third ACK 218 to the second wireless communication device 202b at time t3,3. The second wireless communication device 202b receives the third ACK 218 at time t3,4. Similarly, in a fourth exchange, beginning at time t4,1, the second wireless communication device 202b transmits a fourth FTM frame 220. The fourth FTM frame 220 includes a first field indicating the TOD of the third FTM frame 216 and a second field indicating the TOA of the third ACK 218. The first wireless communication device 202a receives the fourth FTM frame 220 at time t4,2 and transmits a fourth ACK 222 to the second wireless communication device 202b at time t4,3. The second wireless communication device 202b receives the fourth ACK 222 at time t4,4.

The first wireless communication device 202a determines (for example, obtains, identifies, ascertains, calculates, or computes) a range indication in accordance with the TODs and TOAs. For example, in implementations or instances in which an FTM burst includes four exchanges of FTM frames, the first wireless communication device 202a may determine (for example, obtain, identify, ascertain, calculate, or compute) a round trip time (RTT) between itself and the second wireless communication device 202b in accordance with Equation 1.

$$RRT = \frac{1}{3} ( {\sum }_{k = 1}^{3} {t}_{4 , k} - {\sum }_{k = 1}^{3} {t}_{1 , k} ) - ( {\sum }_{k = 1}^{3} {t}_{3 , k} - {\sum }_{k = 1}^{3} {t}_{2 , k} )$$

In some implementations, the range indication is the RTT. Additionally or alternatively, in some implementations, the first wireless communication device 202a may determine (for example, obtain, identify, ascertain, calculate, or compute) an actual approximate distance between itself and the second wireless communication device 202b, for example, by multiplying the RTT by an approximate speed of light in the wireless medium. In such instances, the range indication may additionally or alternatively include the distance value. Additionally or alternatively, the range indication may include an indication as to whether the second wireless communication device 202b is within a proximity (for example, a service discovery threshold) of the first wireless communication device 202a in accordance with the RTT. In some implementations, the first wireless communication device 202a may transmit the range indication to the second wireless communication device 202b, for example, in a range report 224 at time t5,1, which the second wireless communication device receives at time t5,2.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

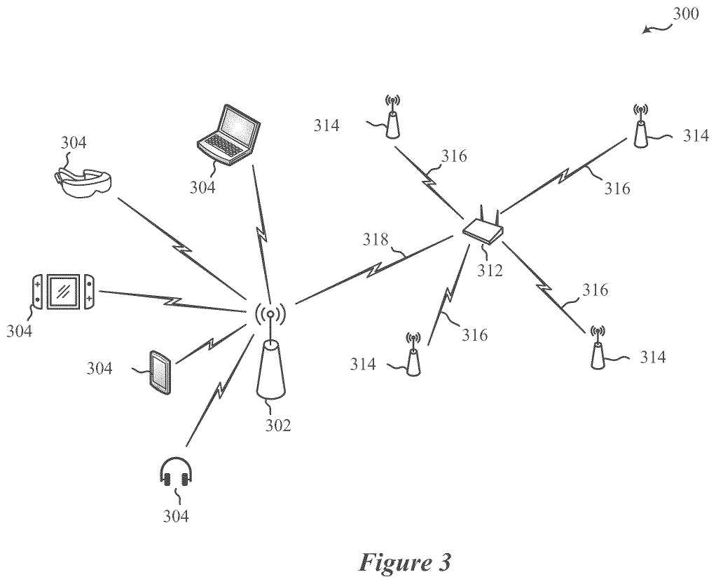

FIG. 3 shows a pictorial diagram of another example wireless communication network 300. According to some aspects, the wireless communication network 300 can be an example of a mesh network, an IoT network or a sensor network in accordance with one or more of the IEEE 802.11 family of wireless communication protocol standards (including the 802.11ah amendment). The wireless communication network 300 may include multiple wireless communication devices 314, which in some implementations may include APs 302, STAs 304, or both. The wireless communication devices 314 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 314 sense, measure, collect or otherwise obtain and process data and transmit such raw or processed data to an intermediate device 312 for subsequent processing or distribution. Additionally, or alternatively, the intermediate device 312 may transmit control information, digital content (for example, audio or video data), configuration information or other instructions to the wireless communication devices 314. The intermediate device 312 and the wireless communication devices 314 can communicate with one another via wireless communication links 316. In some examples, the wireless communication links 316 include Bluetooth links, or other PAN or short-range communication links.

In some examples, the intermediate device 312 also may be configured for wireless communication with other networks such as with a WLAN or a wireless (for example, cellular) wide area network (WWAN), which may, in turn, provide access to external networks including the Internet. For example, the intermediate device 312 may associate and communicate, over a Wi-Fi link 318, with an AP 302 of a wireless communication network 300, which also may serve various STAs 304. In some examples, the intermediate device 312 is an example of a network gateway, for example, an IoT gateway. In such a manner, the intermediate device 312 may serve as an edge network bridge providing a Wi-Fi core backhaul for the IoT network including the wireless communication devices 314. In some examples, the intermediate device 312 can analyze, preprocess and aggregate data received from the wireless communication devices 314 locally at the edge before transmitting it to other devices or external networks via the Wi-Fi link 318. The intermediate device 312 also can provide additional security for the IoT network and the data it transports.

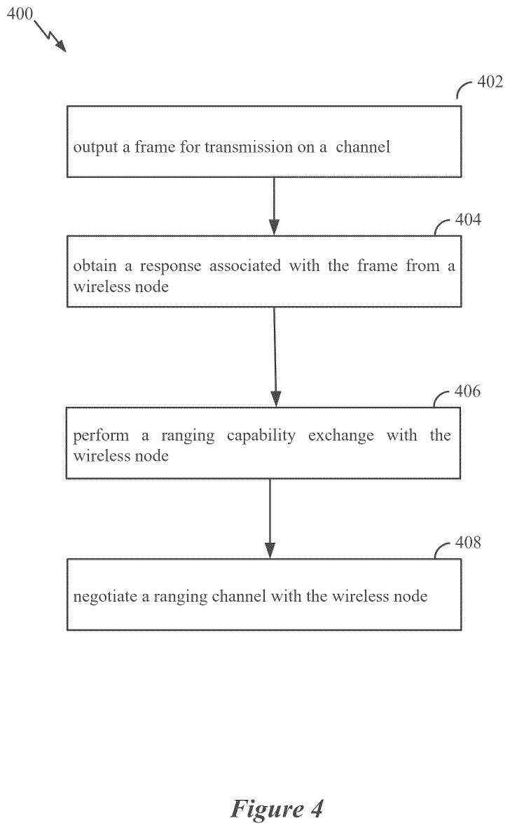

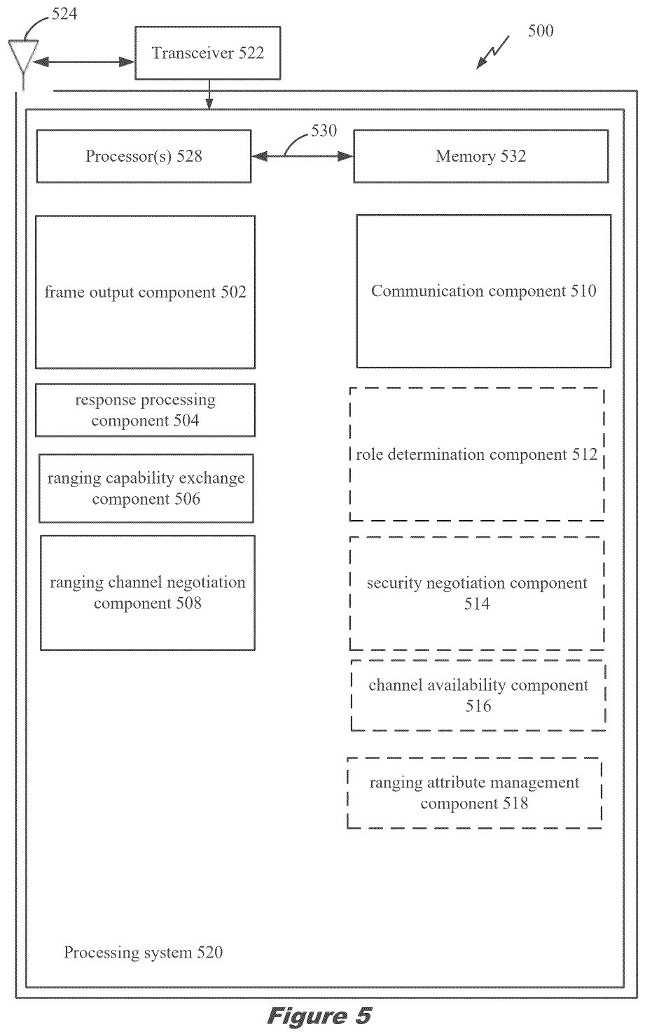

FIG. 4 shows a flowchart illustrating an example process 400 performable by or at a apparatus for wireless communication that supports peer-to-peer ranging according to certain aspects. The operations of the process 400 may be implemented by a wireless station or its components as described herein. For example, the process 400 may be performed by a wireless communication device, such as the wireless communication device 500 described with reference to FIG. 5, operating as or within a wireless station. In some examples, the process 400 may be performed by a wireless station such as one of the stations 104 described with reference to FIG. 1.

At step 402, the apparatus outputs a frame for transmission on a discovery channel. Step 402 is performed to initiate the discovery process by broadcasting the device's presence and capabilities to nearby devices. The frame may contain information about the device's ranging capabilities and other relevant parameters.

At step 404, the apparatus obtains a response associated with the frame from a wireless node. The response indicates the identification of a potential peer for ranging operations. The content of this response may include information about the wireless node's ranging capabilities and other relevant parameters, allowing for initial compatibility assessment.

At step 406, the apparatus performs a ranging capability exchange with the wireless node. During this exchange, devices share detailed information about their ranging capabilities. A specific implementation might include the exchange of one or more ranging attributes comprising fields such as Location Information Availability, Ranging Protocol Type, or Ranging Band Information, which provide data for establishing compatible ranging parameters.

At step 408, the apparatus negotiates a ranging channel with the wireless node based on the previously exchanged capabilities. Through this negotiation, both devices come to an agreement on the specific channel for subsequent ranging operations. Doing so ensures optimal use of available spectrum resources for the ranging activities.

In certain scenarios, the process may incorporate additional steps or considerations. For example, after the initial frame output at step 402, the apparatus might transmit a follow-up frame, indicating its intention to remain on the discovery channel for further exchanges. Following the ranging capability exchange in step 406, the apparatus may operate as either an initiating station (ISTA) or a responding station (RSTA) for the ranging operation. Factors influencing this decision may include service type or subscriber roles, thereby allowing the device to adapt its behavior based on the specific requirements of the ranging session.

Security considerations may prompt the execution of a Pre-Association Security Negotiation (PASN) between the two apparatuses. PASN is typically performed before establishing a full data channel with the wireless node. This negotiation establishes mutual authentication and encryption keys, which are then used to protect the confidentiality and integrity of subsequent ranging communications.

The ranging attributes exchanged in step 406 may include additional fields in some implementations. For example, the additional fields could include a Last Movement Indication field, a 2.4 GHz Ranging Channel ID field, a 5 GHz Ranging Channel ID field, or a 6 GHz Ranging Channel ID field. These additional fields provide more comprehensive information about the device's ranging capabilities and preferences.

After negotiating the ranging channel in step 408, the apparatus may obtain channel availability for subsequent ranging operations. This assessment relies on the information contained in the exchanged ranging attributes, ensuring that the selected channel is indeed available and suitable for the intended ranging operation.

It should be noted that the Location Information Availability field may indicate availability of local coordinates, geospatial location information, civic location information, or last movement indication. The Ranging Protocol Type field may indicate support for 802.11 protocol ranging or Proximity NTB ranging. As such, the Ranging Band Information field may indicate availability of 2.4 GHZ, 5 GHZ, or 6 GHz Ranging Channels.

Throughout the process 400, the apparatus can employ a transceiver to manage various communications. These include frame transmission, reception of responses, capability exchange, and channel negotiation. Configured as a wireless station, the apparatus can efficiently perform these peer-to-peer ranging operations, adapting to the needs of the current network environment and ranging requirements.

FIG. 5 shows a block diagram of an example wireless communication device 500 that supports peer-to-peer ranging according to certain aspects. In some examples, the wireless communication device 500 is configured to perform the process 400 described with reference to FIG. 4. The wireless communication device 500 may include one or more chips, SoCs, chipsets, packages, components or devices that individually or collectively constitute or include a processing system. The processing system may interface with other components of the wireless communication device 500, and may generally process information received from such other components and output information to such other components.

The processing system includes processor (or “processing”) circuitry in the form of one or multiple processors, microprocessors, processing units (such as central processing units (CPUs), graphics processing units (GPUs), neural processing units (NPUs), or digital signal processors (DSPs)), processing blocks, application-specific integrated circuits (ASIC), programmable logic devices (PLDs), or other discrete gate or transistor logic or circuitry. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof.

Device 500 includes processing system 520 coupled to transceiver 522 (e.g., a transmitter and/or a receiver). Transceiver 522 is configured to transmit and receive signals for device 500 via antenna 524, such as the various signals as described herein. A network interface is configured to obtain and send signals for the wireless communication device 500 via communications link(s), such as described herein with respect to FIG. 1. Processing system 520 may be configured to perform processing functions for device 500, including processing signals received and/or to be transmitted by device 500.

Processing system 520 includes one or more processors 528. In various aspects, one or more processors 528 may be representative of one or more of receive processor, transmit processor, and/or controller/processor. The one or more processors 528 are coupled to computer-readable medium/memory 530 via bus 532. Computer-readable medium/memory 530 is configured to store instructions (e.g., computer-executable code, processor-executable code) that when executed by the one or more processors 528, cause the one or more processors 528 to perform method 400 described with respect to FIG. 4, or any aspect related to it.

The wireless communication device 500 includes a frame output component 502, a response processing component 504, a ranging capability exchange component 506, a ranging channel negotiation component 508, and a communication component 510. Portions of one or more of these components may be implemented at least in part in hardware or firmware. For example, the frame output component 502 may be implemented at least in part by a processor or a modem. In some examples, portions of one or more of these components may be implemented at least in part by a processor and software in the form of processor-executable code stored in the memory.

The frame output component 502 is configurable or configured to output, for transmission on a discovery channel, a frame. This component initiates the discovery process, allowing the device to announce its presence and capabilities to other devices in the vicinity.

The response processing component 504 is configured to obtain a response associated with the frame from a wireless node. This component processes the received information, identifying potential peers for ranging operations.

The ranging capability exchange component 506 is configured to perform a ranging capability exchange with the wireless node. This component facilitates the exchange of detailed information regarding the ranging capabilities of each device, including the transmission and reception of one or more ranging attributes.

The ranging channel negotiation component 508 is configured to negotiate a ranging channel with the wireless node according to the exchanged ranging capability. The component determines and establishes agreement on a specific channel for subsequent ranging operations between the devices.

The communication component 510 manages various communications for the device. Its functions include transmitting the frame, receiving responses, and facilitating data exchange for the ranging capability exchange and channel negotiation processes.

The wireless communication device 500 can also include a role determination component 512. This component is configured to operate the device as either an initiating station (ISTA) or a responding station (RSTA) for a ranging operation. The determination is based on factors such as service type or subscriber roles.

A security negotiation component 514 is included in device 500. This component is configured to establish a data channel with the wireless node after the ranging channel negotiation and perform a Pre-Association Security Negotiation (PASN) with the wireless node via the data channel. The PASN process establishes secure parameters for subsequent ranging communications.

The device 500 also includes a channel availability component 516. This component is configured to obtain channel availability for subsequent ranging operations. It utilizes the information contained in the exchanged ranging attributes to make these determinations.

A ranging attribute management component 518 is configured to manage the ranging attributes. This component enables the device to process and utilize various fields within the ranging attributes, such as the Location Information Availability field, Ranging Protocol Type field, and Ranging Band Information field.

This architecture enables the wireless communication device 500 to perform efficient ranging, balancing the need for accurate positioning information with effective discovery and capability exchange. The device 500 can adapt its behavior based on the specific requirements of the ranging session and the network environment.

Various components of device 500 may provide means for performing method 400 described with reference to FIG. 4, or any aspect related to it. For example, means for outputting a frame may include the frame output component 502 and the communication component 510. Means for obtaining a response may include the response processing component 504 and the communication component 510. Means for performing a ranging capability exchange may include the ranging capability exchange component 506. Means for negotiating a ranging channel may include the ranging channel negotiation component 508. Means for establishing a data channel may include the communication component 510 and the security negotiation component 514. Means for operating as an ISTA or RSTA may include the role determination component 512. Means for performing a PASN may include the security negotiation component 514. Means for obtaining channel availability may include the channel availability component 516. Means for managing ranging attributes may include the ranging attribute management component 518. These components, individually or in combination, provide the necessary functionality to implement the ranging method as described in this disclosure.

In some examples, the wireless communication device 500 may be configured to perform operations or processes corresponding to the method 400 illustrated in FIG. 4. For example, the frame output component 502 and communication component 510 may perform the operations of outputting a frame for transmission. The response processing component 504 and communication component 510 may perform the operations of obtaining a response. The ranging capability exchange component 506 may perform the operations of performing a ranging capability exchange. The ranging channel negotiation component 508 may perform the operations of negotiating a ranging channel. The role determination component 512, security negotiation component 514, channel availability component 516, and ranging attribute management component 518 may perform additional functions as described herein.

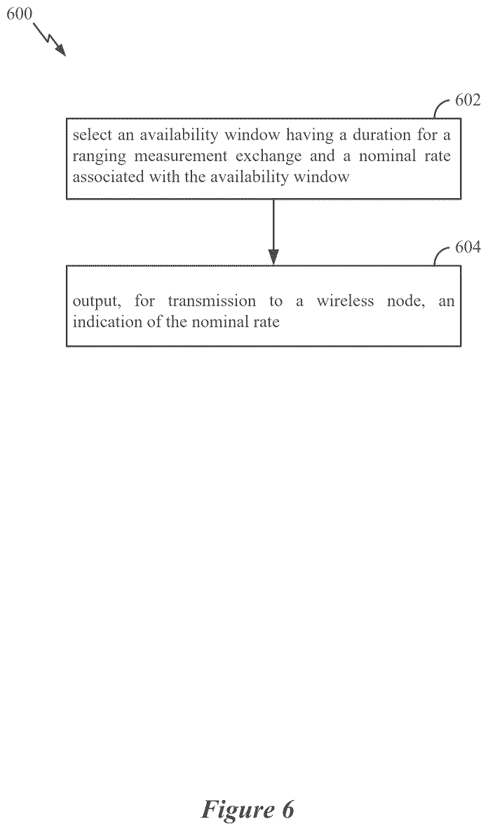

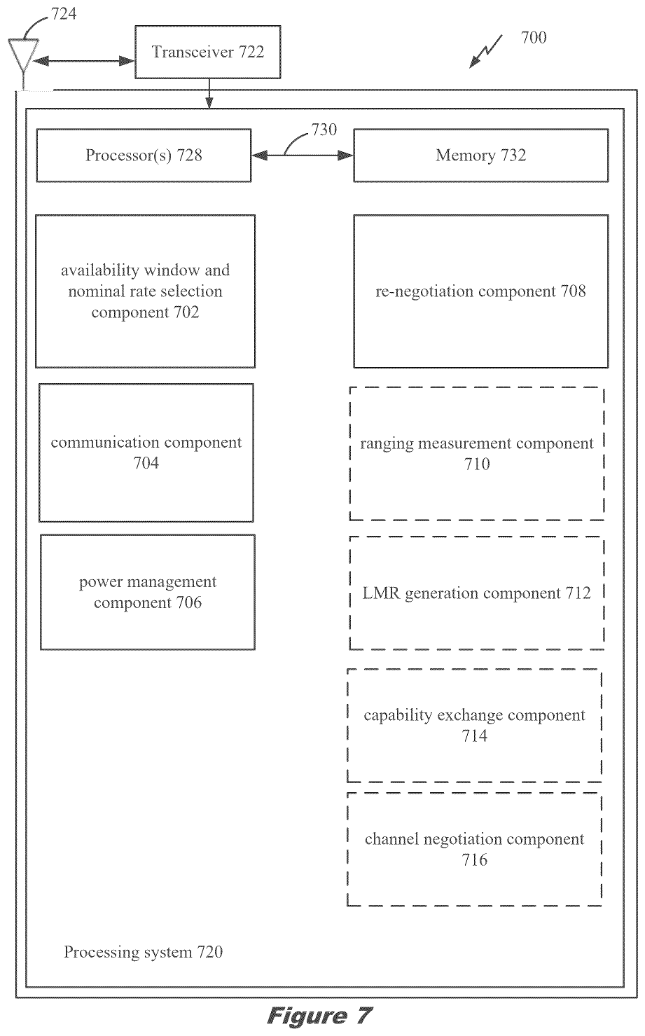

FIG. 6 illustrates a flowchart of an example process 600 performable by or at a wireless station that supports power-optimized peer-to-peer ranging as an initiating station (ISTA) according to certain aspects. The operations of process 600 may be implemented by a wireless station or its components as described herein. For instance, the process 600 could be executed by a wireless communication device, such as the wireless communication device 700 described with reference to FIG. 7, functioning as or within a wireless station. In some scenarios, process 600 might be carried out by a wireless station akin to one of the stations 104 described with reference to FIG. 1.

At step 602, the apparatus selects an availability window having a duration for a ranging measurement exchange and a nominal rate associated with the availability window. This selection process considers various factors, including the requirements of one or more applications running on the apparatus. The availability window serves as a designated time frame for ranging activities, while the nominal rate determines the frequency of these exchanges.

The selection in step 602 plays a role in the device's power management strategy. By defining both the duration and frequency of ranging activities, the apparatus can effectively schedule its active periods. Consequently, during the intervals between these predetermined availability windows, the device can transition into a low-power state, significantly reducing its energy consumption. This approach is effective for extended ranging sessions and allows the apparatus to fine-tune its power consumption based on the varying demands of different applications.

In step 604, the apparatus outputs an indication of the nominal rate for transmission to a wireless node. Sharing this information enables coordinated ranging efforts that align with the apparatus's operational constraints and application needs. Further, selection of the availability window and/or the nominal rate enables a low power state between consecutive availability windows.

In some implementations, the low power state enabled between consecutive availability windows may comprise various power-saving techniques. For example, the apparatus may enter a sleep mode where most of its components, including the main processor and radio transceiver, are powered down, leaving only a low-power timer active to trigger wake-up for the next availability window. Alternatively, or additionally, the apparatus may implement partial radio shutdown, where the main processor remains in a low-power state while the radio transceiver is completely deactivated. In other implementations, the apparatus may employ duty cycling, periodically waking briefly to check for critical messages before returning to a low-power state.

According to certain aspects, the low power state may involve dynamic voltage and frequency scaling (DVFS), where the apparatus reduces its processor clock speed and voltage to minimize power consumption while maintaining minimal functionality. The apparatus may also selectively deactivate non-essential components or sensors not required for ranging operations. In some implementations, the apparatus may utilize a low-power listening mode, occasionally switching to a very low-power state to check for wake-up signals rather than maintaining full receiver functionality. The specific low power state employed may be dynamically selected based on factors such as remaining battery life, proximity to other devices, application requirements, or the duration until the next availability window, thereby optimizing power consumption while ensuring the apparatus remains capable of participating in subsequent ranging operations.

Implementations may include additional steps to improve adaptability and efficiency. For instance, the apparatus might obtain a request from the wireless node to re-negotiate the nominal rate. Upon receiving such a request, a re-negotiation process ensues, adjusting the nominal rate to better suit the changing needs of both devices.

During an availability window, the apparatus may obtain a ranging measurement request from the wireless node. In response, it performs one or more ranging measurements and subsequently outputs a location measurement report (LMR) for transmission. The LMR serves a dual purpose by conveying measurement results and potentially indicating the possibility of re-negotiating the nominal rate.

To facilitate efficient communication of re-negotiation needs, the apparatus may employ a specific signaling mechanism. One aspect involves setting a bit in the Time of Arrival (TOA) Error field (or an equivalent or similar structure) of the LMR to indicate a need for nominal rate re-negotiation.

The ranging capabilities of the apparatus are not static and may be communicated dynamically. During an unsynchronized discovery phase, the apparatus can exchange ranging attributes with the wireless node. These attributes may comprise fields such as Location Information Availability, Ranging Protocol Type, or Ranging Band Information, ensuring that subsequent ranging operations are optimized for both devices' capabilities.

The ranging capability information exchanged may include support for both initiating station (ISTA) and responding station (RSTA) roles. This flexibility allows the apparatus to adapt its function based on the specific requirements of each ranging scenario. Additionally, the nominal rate holds particular significance for RSTA devices by influencing the cadence of their availability windows.

The apparatus may engage in a negotiation process with the wireless node during a service discovery phase to determine the most suitable ranging channel. This proactive approach helps minimize interference and optimize ranging performance.

The process 600 also considers mechanisms for re-negotiating the nominal rate. After transmitting an LMR with the re-negotiation bit set, the apparatus may receive a formal request for re-negotiation from the wireless node. This triggers a re-negotiation process, allowing both devices to agree on a new nominal rate that better serves their current needs.

In some implementations, the apparatus may use a maximum time field to indicate the nominal rate, providing a standardized method for communicating the parameter.

During process 600, the apparatus utilizes its transceiver to facilitate communication with the wireless node. For example, when configured as a wireless station, the apparatus can use the transceiver to transmit the indication of the nominal rate and engage in other necessary exchanges for effective peer-to-peer ranging.

FIG. 7 illustrates a block diagram of an example wireless communication device 700 that supports power-optimized peer-to-peer ranging as an initiating station (ISTA). In some examples, the wireless communication device 700 is configured to perform the process 600 described with reference to FIG. 6. The wireless communication device 700 may comprise one or more chips, SoCs, chipsets, packages, components or devices that collectively or individually constitute a processing system. Interfacing with other components of the wireless communication device 700, this processing system processes information received from such components and outputs information to them.

The processing system incorporates processor circuitry, which may include one or multiple processors, microprocessors, or processing units. Memory circuitry, comprising one or more memory devices or blocks, is also part of the processing system. These memory elements may contain tangible storage media such as random-access memory (RAM) or read-only memory (ROM), or combinations thereof.

Device 700 features a processing system 720 coupled to a transceiver 722. The transceiver 722 is tasked with transmitting and receiving signals for device 700 via antenna 724. A network interface 726 obtains and sends signals for the wireless communication device 700 through various communication links. Processing functions for device 700, including signal processing for received and transmitted signals, are handled by processing system 720.

One or more processors 728 are included in processing system 720. These processors may represent various components such as receive processor, transmit processor, or controller/processor, as typically found in a UE architecture. Computer-readable medium/memory 730 connects to the processors 728 via bus 732. When executed by the processors 728, instructions stored in this memory enable the performance of method 600, as described in FIG. 6.

The wireless communication device 700 encompasses various components, including an availability window and nominal rate selection component 702, a communication component 704, and a power management component 706. Implementation of these components may involve hardware, firmware, or a combination of both. For instance, the availability window and nominal rate selection component 702 might be realized through a processor or modem. Some aspects of these components could also be implemented via processor-executable code stored in memory.

The availability window and nominal rate selection component 702 determines the timing and duration of ranging measurement exchanges, as well as the nominal rate associated with the availability window. This component selects intervals during which the device will be available for ranging activities and chooses a rate that corresponds to the requirements of applications running on the device. It considers factors such as efficiency, power conservation, and the frequency of ranging information updates.

The communication component 704 is responsible for outputting the nominal rate information to other devices. This component facilitates the coordination of ranging sessions by communicating the timing parameters to participating devices.

The power management component 706 manages the device's energy consumption between active ranging periods. It enables the device to enter a low-power state during idle periods.

A re-negotiation component 708 handles requests to re-negotiate the nominal rate from other devices. This component manages the process of adjusting the nominal rate to better suit changing needs of both the device and its peers.

The ranging measurement component 710 performs ranging measurements during the availability window. In doing so, it obtains ranging measurement requests from other devices and executes the necessary measurements.

An LMR generation component 712 creates location measurement reports (LMRs) that include the results of ranging measurements. It may also incorporate an indication that re-negotiation of the nominal rate is possible, such as by setting a specific bit in the Time of Arrival (TOA) Error field.

During the initial setup phase, the capability exchange component 714 operates within the unsynchronized discovery phase. This component manages the exchange of ranging attributes between devices, including support for initiating station (ISTA) and responding station (RSTA) roles.

The channel negotiation component 716 is responsible for selecting an appropriate channel for ranging activities. This component can operate during the service discovery phase, and negotiate with peer devices to determine a suitable ranging channel.

The wireless communication device 700 utilizes its transceiver for various communication tasks, including transmitting indications of the nominal rate, sending ranging measurement requests, and receiving responses from peer wireless devices.

Several components of device 700 serve as means for executing method 600, as outlined in FIG. 6. The availability window and nominal rate selection component 702 provides means for selecting an availability window and a nominal rate. The communication component 704 offers means for outputting the nominal rate indication. Means for entering a low power state are furnished by the power management component 706. The re-negotiation component 708 provides means for re-negotiating the nominal rate. The ranging measurement component 710 and LMR generation component 712 offer means for obtaining ranging measurement requests, performing measurements, and generating LMRs. The capability exchange component 714 and transceiver provide means for exchanging ranging attributes, while the channel negotiation component 716 and transceiver offer means for negotiating a ranging channel. Means for establishing a data channel may include the communication component 704 and the channel negotiation component 716. The transceiver provides means for transmitting and receiving various communications. Working in concert, these components enable the implementation of the ranging method as described in this disclosure.

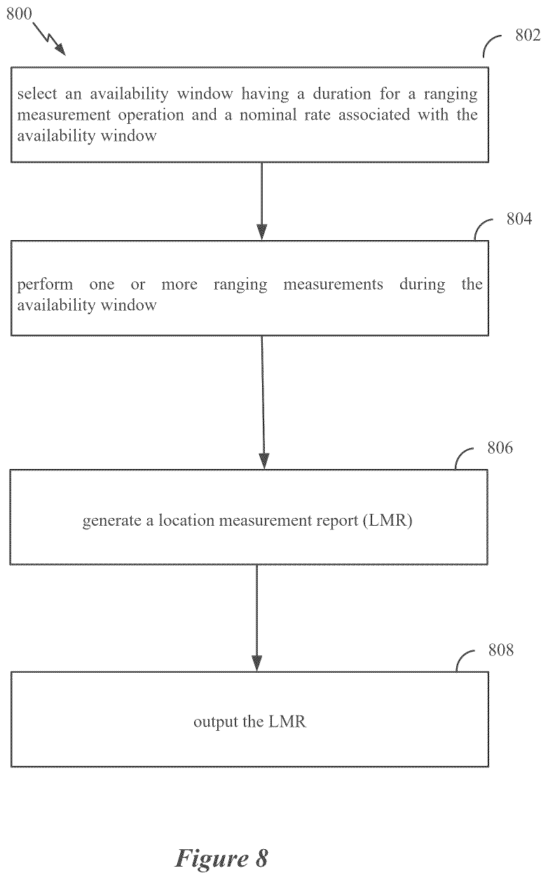

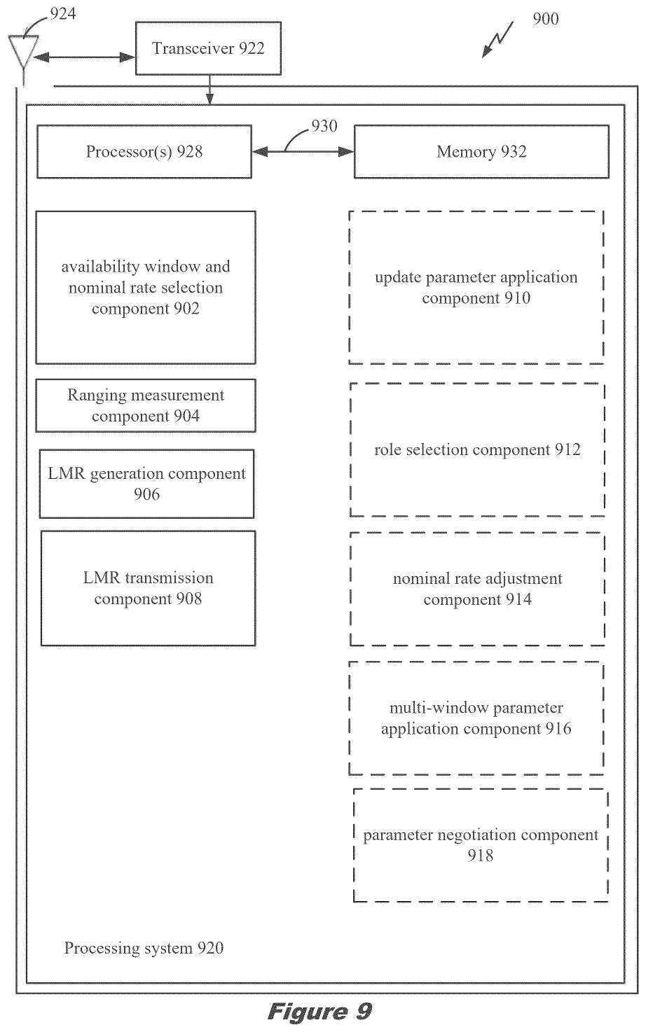

FIG. 8 shows a flowchart illustrating an example process 800 performable by or at a wireless station that supports power-optimized peer-to-peer ranging according to certain aspects. The operations of the process 800 may be implemented by a wireless station or its components as described herein. For example, the process 800 may be performed by a wireless communication device, such as the wireless communication device 900 described with reference to FIG. 9, operating as or within a wireless station. In some examples, the process 800 may be performed by a wireless station such as one of the stations 104 described with reference to FIG. 1.

At step 802, the apparatus selects an availability window having a duration for a ranging measurement operation and a nominal rate associated with the availability window. The nominal rate is linked to one or more applications running on the apparatus. Selection of the availability window and nominal rate considers factors such as the device's capabilities, application requirements, and the need to balance accurate positioning with power conservation.

At step 804, the apparatus performs one or more ranging measurements during the availability window. The measurements may employ various techniques to determine, e.g., the distance or relative position between the apparatus and a peer wireless node participating in the ranging operation.

At step 806, the apparatus generates a location measurement report (LMR). The LMR includes either the results of the ranging measurements or one or more updated parameters for the ranging measurement operation. Updated parameters may comprise an updated nominal rate, an updated availability window duration, or an updated quantity of ranging measurements to be performed in the availability window. At step 808, the apparatus outputs the LMR.

The process may include additional steps to improve functionality and efficiency. For instance, the apparatus might output the LMR for transmission to a wireless node and subsequently apply the updated parameters in the availability window. This allows for dynamic adjustment of the ranging process.

In some implementations, the updated parameters are determined based on the application needs of the apparatus. The device may operate as either an initiating station (ISTA) or a responding station (RSTA) for the ranging measurement operation, outputting the LMR regardless of its configured role. Flexibility in device roles enables adaptation to specific requirements of each ranging scenario.

The apparatus may adjust the nominal rate during the ranging measurement operation based on the updated parameters. To indicate a need for parameter updates, it can set a bit in the Time of Arrival (TOA) Error field of the LMR.

When the ranging measurement operation spans multiple availability windows, the apparatus can apply the updated parameters across these windows. Moreover, it may negotiate the updated parameters with a wireless node during the ranging measurement operation without interrupting ongoing measurements. Such capabilities ensure continuity and efficiency in extended ranging sessions.

The apparatus can utilize a transceiver to manage various communications, including transmitting the LMR. When configured as a wireless station, the apparatus can efficiently perform these peer-to-peer ranging operations, thereby adapting to the current network environment and ranging requirements.

The processing system incorporates processor circuitry, which may include one or multiple processors, microprocessors, or processing units. Memory circuitry, comprising one or more memory devices or blocks, is also part of the processing system. These memory elements may contain tangible storage media such as random-access memory (RAM) or read-only memory (ROM), or combinations thereof. The interplay between the processor and memory components enables the execution of the ranging measurement operations and associated signaling.

Process 800 typically employs a transceiver within the wireless station to handle various communications, including transmitting the LMR with ranging measurement results and updated parameters. According to various aspects, the wireless station may operate as either an initiating station (ISTA) or a responding station (RSTA) during a P2P ranging session.

FIG. 9 illustrates a block diagram of an example wireless communication device 900 that supports power-optimized peer-to-peer ranging. In some examples, the wireless communication device 900 is configured to perform the process 800 described with reference to FIG. 8. The wireless communication device 900 may comprise one or more chips, SoCs, chipsets, packages, components or devices that collectively or individually constitute a processing system. Interfacing with other components of the wireless communication device 900, this processing system processes information received from such components and outputs information to them.

The processing system incorporates processor circuitry, which may include one or multiple processors, microprocessors, or processing units. Memory circuitry, comprising one or more memory devices or blocks, is also part of the processing system. These memory elements may contain tangible storage media such as random-access memory (RAM) or read-only memory (ROM), or combinations thereof.

Device 900 comprises a processing system 920 coupled to a transceiver 922. Antenna 924 facilitates the transmission and reception of signals for device 900 via the transceiver 922. A network interface manages the exchange of signals for the wireless communication device 900 through various communication links. Processing system 920 handles signal processing for received and transmitted signals.

Device 900 comprises a processing system 920 coupled to a transceiver 922. Antenna 924 facilitates the transmission and reception of signals for device 900 via the transceiver 922. A network interface 926 manages the exchange of signals for the wireless communication device 900 through various communication links. Processing system 920 handles signal processing for received and transmitted signals.

Processing system 920 includes one or more processors 928. These processors may represent various components typically found in wireless station architecture, such as receive processor, transmit processor, or controller/processor. Computer-readable medium/memory 930 connects to the processors 928 via bus 932. When executed by the processors 928, instructions stored in this memory enable the performance of method 800, as described in FIG. 8.

The wireless communication device 900 incorporates several components, including: an availability window and nominal rate selection component 902, a ranging measurement component 904, an LMR generation component 906, and an LMR transmission component 908. Implementation of these components may involve hardware, firmware, or a combination of both. For example, the availability window and nominal rate selection component 902 might be realized through a processor or modem. Some aspects of these components could also be implemented via processor-executable code stored in memory.

Availability window and nominal rate selection component 902 is responsible for selecting an availability window with an appropriate duration for ranging measurement operations and determining a nominal rate associated with the window. It considers factors such as device capabilities, ranging protocol requirements, and the needs of applications running on the device to determine suitable time intervals and frequencies for ranging activities.

Ranging measurement component 904 performs the actual ranging measurements during the selected availability window. It employs various techniques to determine the distance or relative position between the device and its peer wireless node.

LMR generation component 906 creates location measurement reports that include either the results of ranging measurements or updated parameters for the ranging measurement operation. These updated parameters may involve adjustments to the nominal rate, availability window duration, or the quantity of ranging measurements to be performed in the window.

The LMR transmission component 908 manages the sending of generated LMRs to the peer wireless node. It ensures that ranging results or updated parameters are effectively communicated to facilitate ongoing coordination between the devices.

An update parameter application component 910 is included to apply the updated parameters in the availability window. This component enables the device to adapt its ranging behavior based on changing requirements or conditions.

Device 900 may also include a role selection component 912, which allows the device to operate as either an initiating station (ISTA) or a responding station (RSTA) for the ranging measurement operation. This flexibility enables the device to adapt to various ranging scenarios.

A nominal rate adjustment component 914 can adjust the nominal rate during the ranging measurement operation based on the updated parameters. This component works in conjunction with the LMR generation component 906, which may set a bit in the Time of Arrival (TOA) Error field of the LMR to indicate a need for parameter updates.

For ranging operations that span multiple availability windows, a multi-window parameter application component 916 ensures that updated parameters are applied across these windows. Additionally, a parameter negotiation component 918 allows the device to negotiate updated parameters with a wireless node during the ranging measurement operation without interrupting ongoing measurements.

Device 900 utilizes its transceiver for various communication tasks related to ranging operations. These include transmitting LMRs with ranging measurement results or updated parameters, as well as participating in capability exchange and channel negotiation processes.

The processing system incorporates processor circuitry, which may include one or multiple processors, microprocessors, or processing units. Memory circuitry, comprising one or more memory devices or blocks, is also part of the processing system. These memory elements may contain tangible storage media such as random-access memory (RAM) or read-only memory (ROM), or combinations thereof. This architecture allows wireless communication device 900 to perform the ranging measurement operations described in method 800. By dynamically selecting availability windows and nominal rates, performing measurements, and updating ranging parameters based on current needs, the device offers a flexible approach to ranging across various scenarios.

Several components of device 900 serve as means for executing method 800, as outlined in FIG. 8. The availability window and nominal rate selection component 902 provides means for selecting an availability window and a nominal rate. The ranging measurement component 904 offers means for performing ranging measurements. The LMR generation component 906 and LMR transmission component 908 provide means for generating and transmitting LMRs. The update parameter application component 910 furnishes means for applying updated parameters. The role selection component 912 offers means for operating as either an ISTA or RSTA. The nominal rate adjustment component 914 provides means for adjusting the nominal rate during operations. The multi-window parameter application component 916 and parameter negotiation component 918 offer means for applying parameters across multiple windows and negotiating parameters without interrupting measurements. Means for establishing a data channel may include the LMR transmission component 908 and the parameter negotiation component 918. The transceiver provides means for various communication tasks. Working in concert, these components enable the implementation of the ranging measurement method as described in this disclosure.

Several components of device 900 serve as means for executing method 800, as outlined in FIG. 8. The availability window and nominal rate selection component 902 provides means for selecting an availability window and a nominal rate. The ranging measurement component 904 offers means for performing ranging measurements. The LMR generation component 906 and LMR transmission component 908 provide means for generating and transmitting LMRs. The update parameter application component 910 furnishes means for applying updated parameters. The role selection component 912 offers means for operating as either an ISTA or RSTA. The nominal rate adjustment component 914 provides means for adjusting the nominal rate during operations. The multi-window parameter application component 916 and parameter negotiation component 918 offer means for applying parameters across multiple windows and negotiating parameters without interrupting measurements. The transceiver provides means for various communication tasks. Working in concert, these components enable the implementation of the ranging measurement method as described in this disclosure.

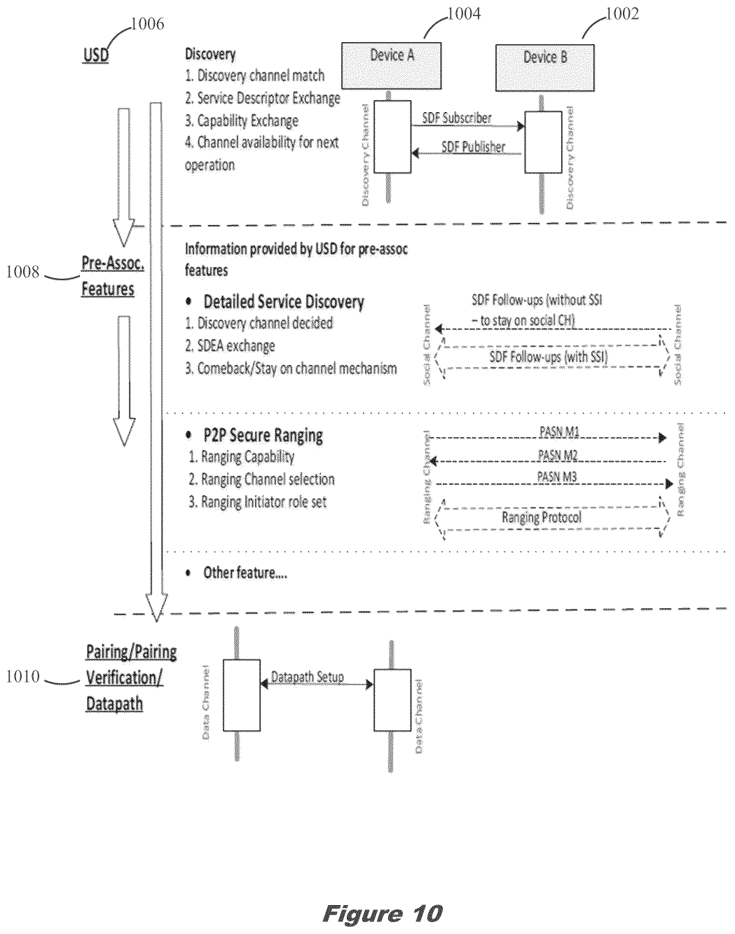

FIG. 10 is a signaling diagram illustrating an example process 1000 that supports peer-to-peer (P2P) ranging communication between one device, e.g., an initiator device 1002, and another device, e.g., a responder device 1004. As shown in FIG. 10, process 1000 includes communication between initiator 1002 and responder 1004, which may be included in a wireless network. Either device may function as a publisher or a subscriber or as a responder or an initiator according to context. The process 1000 demonstrates the establishment of a P2P ranging session, including device discovery, capability exchange, security negotiation, and the implementation of power-saving mechanisms through the use of availability windows and nominal rates according to aspects described herein.

According to certain aspects, the process 1000 is divided into three main stages: Unsynchronized Service Discovery (USD) 1006, Pre-Association Features Stage 1008, and Pairing/Datapath Stage 1010. Each stage contains multiple signaling steps that facilitate the establishment and optimization of the ranging-based communication.

In the following description of process flow 1000, the operations may be performed in a different order than the order shown, or other operations may be added or removed from the process flow 1000. Although the initiator 1002 and responder 1004 are shown performing the operations of process flow 1000, some aspects of some operations may also be performed by one or more other wireless devices or network devices.

The USD stage 1006 begins with the initiator 1002 initiating a channel match procedure. In doing so, the initiator 1002 can output a frame, e.g., a Service Discovery Frame (SDF), either as a subscriber or a publisher, for transmission on a channel. The channel may be a discovery channel. The frame initiates the discovery channel match process by broadcasting the device's presence and capabilities to nearby devices. Here, the frame, e.g., an SDF, can be used to determine if there is a channel match between the devices.

If a channel match is found, the USD stage 1006 proceeds with a service descriptor exchange between the initiator 1002 and responder 1004. This exchange allows the devices to share more detailed information about their services and capabilities.

Following the service descriptor exchange, the devices engage in a capability exchange. During this step, both devices share comprehensive information about their ranging capabilities, including supported protocols and frequency bands.

The final step in the USD stage 1006 is determining channel availability for the next operation. This information helps in selecting an appropriate channel for subsequent stages of the P2P ranging process.

The process 1000 then moves to the Pre-Association Features stage 1008. This stage is divided into two main parts: a Detailed Discovery Service procedure and a P2P Secure Ranging procedure.

The Detailed Discovery Service procedure begins with deciding on a discovery channel for further communication. Once the channel is decided, the devices perform a Service Discovery Exchange Architecture (SDEA) exchange, which provides a framework for more detailed service discovery.

Following the SDEA exchange, the initiator 1002 transmits SDF follow-ups. These follow-ups serve multiple purposes: (1) for publishers, SDF follow-ups with Service Specific Information (SSI) provide additional details about the offered services and the device's capabilities, and (2) for subscribers, SDF follow-ups without SSI indicate the device's intention to stay on the discovery channel for further exchanges.

After handling SDF follow-ups, the devices implement a comeback/stay on channel mechanism. This mechanism allows devices to schedule future interactions on the discovery channel or indicate their intention to remain on the current channel for extended exchanges.

The P2P Secure Ranging part of stage 1008 starts with a ranging capability exchange. This exchange builds upon the initial capability information shared in the USD stage and provides more specific details about each device's ranging capabilities.

Based on the exchanged capabilities, the devices then perform ranging channel selection, choosing an optimal channel for the actual ranging operations.

Following the ranging channel selection, the devices perform a Pre-Association Security Negotiation (PASN). This negotiation establishes secure parameters for the ranging communications. In some implementations the PASN involves a three-message exchange (PASN M1, PASN M2, PASN M3) to establish the secure parameters.

The final step in the P2P Secure Ranging part is setting the ranging initiator role. This determines which device will initiate the ranging measurements in subsequent operations.

The Pairing/Datapath stage 1010 represents the final phase of the peer-to-peer (P2P) ranging process. As illustrated, stage 1010 commences with the establishment of a data channel between the two communicating devices. The data channel provides a dedicated communication link for the exchange of ranging-related information and measurements.

Upon establishing the data channel the devices engage in a ranging protocol. The ranging protocol, as described herein, encompasses a series of message exchanges designed to facilitate accurate distance measurements between the participating devices. These exchanges may include various types of packets and frames specifically tailored for ranging purposes.

According to the ranging protocol, the devices perform multiple ranging measurements within defined availability windows. An availability window represents a specific time duration during which both devices are active and prepared to engage in ranging operations.

Following completion of ranging measurements, both the initiating station (ISTA) and the responding station (RSTA) can generate and exchange Location Measurement Reports (LMRs). These LMRs convey the results of the ranging measurements and provide a mechanism for indicating the need for parameter updates. For instance, the RSTA can indicate a need for re-negotiation by setting a specific bit in its LMR. Upon receiving an LMR with the re-negotiation bit set, the ISTA initiates a re-negotiation process in the subsequent availability window.

According to certain aspects, the re-negotiation process may involve adjustments to various parameters, including the duration of the availability window, the frequency of these windows (referred to as the nominal rate), and the number of measurements performed within each window. These adjustments enable the devices to balance the trade-offs between ranging accuracy, power consumption, and application-specific needs.

Throughout the Pairing/Datapath stage, the devices implement power-saving strategies by entering low-power states between availability windows. The power-saving mechanism is particularly beneficial for the RSTA, which must remain available for ranging with the ISTA.

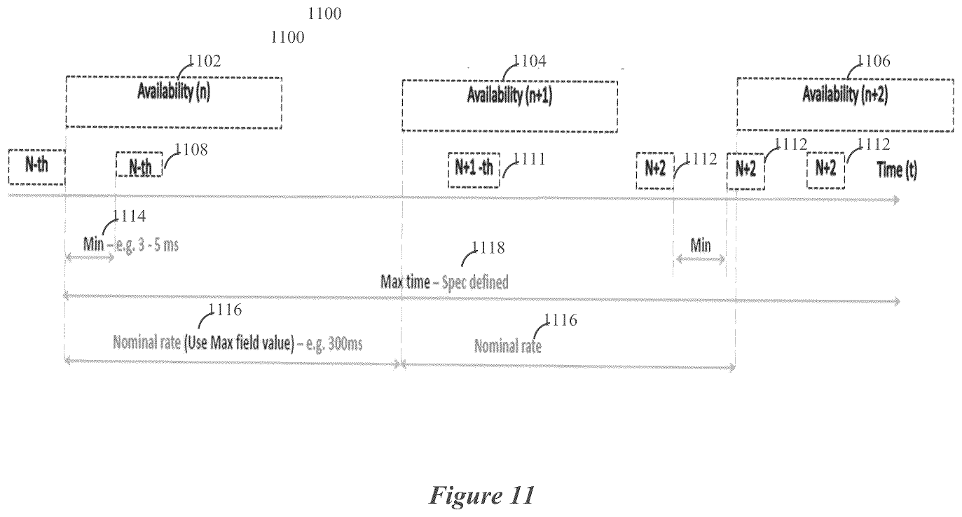

FIG. 11 illustrates a timeline 1100 for power-optimized peer-to-peer (P2P) ranging. The relationship between various timing parameters and the structure of availability windows is shown. Timeline 1100 progresses from left to right, showing a series of availability windows: Availability Window (n) 1102, Availability Window (n+1) 1104, and Availability Window (n+2) 1106. Each availability window has a duration of approximately 15 ms according to some implementations. Within these windows, measurement points are indicated, such as the N-th measurement 1108 in Window (n) and the (N+1)-th measurement 1111 in Window (n+1). A potential (N+2)-th measurement 1112 is shown after Window (n+1).

FIG. 11 further illustrates at least three timing parameters: the Min time 1114, which in some implementations ranges from 3-5 ms; the Nominal rate 1116, shown as am interval between consecutive availability window starts, which is approximately 300 ms in some implementations, and the Max time 1118, which can encompass multiple availability windows.

The power-optimized peer-to-peer (P2P) ranging processes described herein can incorporate a Time of Arrival (TOA) Error field as part of the Location Measurement Report (LMR). This field can include Bits B0-B4 for the Max TOA Error Exponent, Bit B5 for re-negotiation needs, and Bits B6-B7 can be reserved. Here, setting the value of Bit B5 triggers a re-negotiation process in a subsequent availability window. This mechanism allows the Responding Station (RSTA) to remain in a power-saving state between availability windows while still maintaining the ability to optimize its ranging activities. Multiple measurements can occur within a single window to improve active time use. Further, the concept of a “nominal rate” describes features such as a cadence of the availability windows.

Each of a ISTA and a RSTA can send Location Measurement Reports (LMRs). The RSTA can indicate the need for re-negotiation by setting the a bit, e.g., the B5 bit, to 1 in a field, e.g., a time of arrival (TOA) Error field. This enables dynamic ranging where the RSTA has the ability to change the rate of the Availability Window. Upon receiving an LMR with the bit set to 1, the ISTA initiates re-negotiation in the next Availability Window. Further, this approach provides a mechanism for the RSTA to optimize its availability based on use case needs. As a result, adaptive adjustment of the ranging parameters to meet changing application requirements is realized.

In view of the foregoing, the timeline 1100 illustrated in FIG. 11 demonstrates an implementation of certain power-optimized P2P ranging process techniques. It shows how the availability windows, measurement points, and timing parameters interact, and how setting the B5 bit in the TOA Error field can trigger re-negotiation.

Implementation examples are described in the following numbered clauses:
Clause 1: A method for wireless communication at a wireless node, the method comprising: outputting, for transmission on a channel, a frame; obtaining a response associated with the frame from a wireless node; performing, after obtaining the response, a ranging capability exchange with the wireless node, wherein the ranging capability exchange includes exchanging one or more ranging attributes; and negotiating a ranging channel with the wireless node according to the exchanged ranging capability.
Clause 2: The method of Clause 1, wherein the one or more ranging attributes comprise at least one of: a Location Information Availability field, a Ranging Protocol Type field, or a Ranging Band Information field.
Clause 3: The method of Clause 1, further comprising: outputting, for transmission, an indication on the channel for another exchange.
Clause 4: The method of Clause 1, further comprising: operating, according to at least one of a service type or a subscriber status, as at least one of an initiating station (ISTA) or a responding station (RSTA) associated with a ranging operation.
Clause 5: The method of Clause 1, further comprising: establishing a data channel with the wireless node after the ranging channel negotiation; and performing a Pre-Association Security Negotiation (PASN) with the wireless node via the data channel.
Clause 6: The method of Clause 1, wherein the one or more ranging attributes further comprise at least one of: a Last Movement Indication field; a 2.4 GHz ranging channel ID field; a 5 GHz ranging channel ID field; or a 6 GHz ranging channel ID field.
Clause 7: The method of Clause 1, further comprising: obtaining channel availability for a subsequent ranging operation according to the one or more ranging attributes.
Clause 8: The method of Clause 1, wherein the frame comprises a Service Discovery Frame (SDF).
Clause 9: The method of Clause 2, wherein the Location Information Availability field indicates availability of at least one of: local coordinates; geospatial location information; civic location information; or last movement information.
Clause 10: The method of Clause 2, wherein the Ranging Protocol Type field indicates support for at least one of: 802.11REVmc protocol ranging; or proximity NTB ranging.
Clause 11: The method of Clause 2, wherein the Ranging Band Information field indicates availability of at least one of: a 2.4 GHz ranging channel; a 5 GHz ranging channel; or a 6 GHz ranging channel.
Clause 12: The method of Clause 1, further comprising: transmitting the frame and receiving the response using at least one transceiver.
Clause 13: A method for wireless communication, the method comprising: selecting an availability window having a duration for a ranging measurement exchange and a nominal rate associated with the availability window, wherein the nominal rate is associated with one or more applications running on an apparatus; outputting, for transmission to a wireless node, an indication of the nominal rate; and wherein selecting at least one of the availability window or the nominal rate enables a low power state between consecutive availability windows.
Clause 14: The method of Clause 13, further comprising: obtaining, from the wireless node, a request to re-negotiate the nominal rate; and re-negotiating the nominal rate.
Clause 15: The method of Clause 13, further comprising: obtaining a ranging measurement request from the wireless node during the availability window; performing one or more ranging measurements after obtaining the ranging measurement request; and outputting, for transmission, a location measurement report (LMR), the LMR including a result of the one or more ranging measurements.
Clause 16: The method of Clause 15, wherein the LMR further includes an indication that re-negotiation of the nominal rate is possible.
Clause 17: The method of Clause 15, further comprising: setting a bit in a field of the LMR to indicate a need for re-negotiation of the nominal rate.
Clause 18: The method of Clause 13, further comprising at least one of: exchanging one or more ranging attributes with the wireless node during an unsynchronized discovery phase; or wherein the one or more ranging attributes include at least one of: a Location Information Availability field, a Ranging Protocol Type field, or a Ranging Band Information field.
Clause 19: The method of Clause 18, wherein the one or more ranging attributes enables operation as at least one of an initiating station (ISTA) role and a responding station (RSTA) role.
Clause 20: The method of Clause 13, further comprising: negotiating a ranging channel with the wireless node during a service discovery phase.
Clause 21: The method of Clause 15, further comprising: outputting, for transmission to the wireless node, the LMR with an indication of a need for re-negotiation of the nominal rate; obtaining, from the wireless node, a request for re-negotiation of the nominal rate; and re-negotiating the nominal rate with the wireless node.
Clause 22: The method of Clause 13, wherein the nominal rate is associated with a time that is between the availability window and another availability window.
Clause 23: The method of Clause 13, further comprising: using a Maximum Time field to indicate the nominal rate.
Clause 24: The method of Clause 13, further comprising: transmitting the indication of the nominal rate using a transceiver.
Clause 25: A method for wireless communication at a wireless node, the method comprising: selecting an availability window having a duration for a ranging measurement operation and a nominal rate associated with the availability window, wherein the nominal rate is associated with one or more applications running on an apparatus; performing one or more ranging measurements during the availability window; generating a location measurement report (LMR) including at least one of: a result of the one or more ranging measurements, or one or more updated parameters associated with the ranging measurement operation, wherein the one or more updated parameters comprise at least one of an updated nominal rate, an updated availability window duration, or an updated quantity of ranging measurements to be performed in the updated availability window; and outputting, for transmission to a wireless node, the LMR.
Clause 26: The method of Clause 25, wherein the one or more updated parameters are based on an application need of the apparatus, and wherein the method further comprises: operating as at least one of an initiating station (ISTA) or a responding station (RSTA) for the ranging measurement operation; and outputting the LMR regardless of whether the apparatus is configured to operate as the ISTA or the RSTA.
Clause 27: The method of Clause 25, further comprising: adjusting the nominal rate during the ranging measurement operation based on the one or more updated parameters.
Clause 28: The method of Clause 25, further comprising: setting a bit in a field of the LMR to indicate a need for updating one or more parameters.
Clause 29: The method of Clause 25, wherein the ranging measurement operation spans one or more availability windows, and wherein the method further comprises: applying the one or more updated parameters during the one or more availability windows.
Clause 30: The method of Clause 25, further comprising: negotiating the one or more updated parameters with a wireless node in parallel with performing the one or more ranging measurements.
Clause 31: The method of Clause 25, further comprising: transmitting the location measurement report (LMR) using at least one transceiver.
Clause 32: An apparatus, including means for performing a method in accordance with any combination of Clauses 1-31.
Clause 33: A non-transitory computer-readable medium including executable instructions that, when executed by at least one processor of an apparatus, cause the apparatus to perform a method in accordance with any combination of Clauses 1-31.
Clause 34: A computer program product embodied on a computer-readable storage medium including code for performing a method in accordance with any combination of Clauses 1-31.
Clause 35: A wireless node (e.g., a station), comprising: one or more transceivers; one or more processors; and one or more memories comprising instructions executable by the one or more processors to cause the wireless node to perform a method in accordance with any combination of Clauses 1-12, wherein the at least one transceiver is configured to transmit the frame and to receive the response.
Clause 36: A wireless node (e.g., a station), comprising: one or more transceivers; one or more processors; and one or more memories comprising instructions executable by the one or more processors to cause the wireless node to perform a method in accordance with any combination of Clauses 13-24, wherein the at least one transceiver is configured to transmit the indication of the nominal rate.
Clause 37: A wireless node (e.g., a station), comprising: one or more transceivers; one or more processors; and one or more memories comprising instructions executable by the one or more processors to cause the wireless node to perform a method in accordance with any combination of Clauses 25-34, wherein the at least one transceiver is configured to transmit the location measurement report (LMR).
Clause 38: An apparatus for wireless communication, comprising: a processing system that includes one or more processors and one or more memories coupled with the one or more processors, the processing system configured to cause the apparatus to: perform a method in accordance with any combination of Clauses 1-31.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only “a,”” or the equivalent in context, whatever it is that is “based on “a,”” or “based at least in part on “a,”” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
a processing system that includes one or more processors and one or more memories coupled with the one or more processors, the processing system configured to cause the apparatus to:
output, for transmission on a channel, a frame;
obtain a response associated with the frame from a wireless node;
perform, after obtaining the response, a ranging capability exchange with the wireless node, wherein the ranging capability exchange includes exchanging information associated with one or more ranging attributes; and
negotiate a ranging channel with the wireless node according to the exchanged ranging capability.

2. The apparatus of claim 1, wherein the processing system is further configured to cause the apparatus to:
establish a data channel with the wireless node after the ranging channel negotiation; and
perform a Pre-Association Security Negotiation (PASN) with the wireless node via the data channel.

3. An apparatus for wireless communication, comprising:
a processing system that includes one or more processors and one or more memories coupled with the one or more processors, the processing system configured to cause the apparatus to:
select an availability window having a duration for a ranging measurement exchange and a nominal rate associated with the availability window, wherein the nominal rate is associated with one or more applications running on the apparatus; and
output, for transmission to a wireless node, an indication of the nominal rate,
wherein the selection of at least one of the availability window or the nominal rate enables a low power state between consecutive availability windows.

4. The apparatus of claim 3, wherein the processing system is further configured to cause the apparatus to:
obtain, from the wireless node, a request to re-negotiate the nominal rate; and
re-negotiate the nominal rate.

5. The apparatus of claim 3, wherein the processing system is further configured to cause the apparatus to:
obtain a ranging measurement request from the wireless node during the availability window;
perform one or more ranging measurements after obtaining the ranging measurement request; and
output, for transmission, a location measurement report (LMR), the LMR including a result of the one or more ranging measurements.

6. The apparatus of claim 5, wherein the LMR further includes an indication that re-negotiation of the nominal rate is possible.

7. The apparatus of claim 5, wherein the processing system is further configured to cause the apparatus to:
set a bit in a field of the LMR to indicate a need for re-negotiation of the nominal rate.

8. The apparatus of claim 3, wherein at least one of:
the processing system is further configured to exchange one or more ranging attributes with the wireless node during an unsynchronized discovery phase; or
the one or more ranging attributes include at least one of: a Location Information Availability field, a Ranging Protocol Type field, or a Ranging Band Information field.

9. The apparatus of claim 8, wherein the one or more ranging attributes enable operation of at least one of an initiating station (ISTA) role or a responding station (RSTA) role.

10. The apparatus of claim 3, wherein the processing system is further configured to cause the apparatus to:
negotiate a ranging channel with the wireless node during a service discovery phase.

11. The apparatus of claim 5, wherein:
the LMR further includes an indication of a need for re-negotiation of the nominal rate; and
the processing system is further configured to:
obtain, from the wireless node, a request for re-negotiation of the nominal rate; and
re-negotiate the nominal rate with the wireless node.

12. The apparatus of claim 3, The apparatus of claim 3, wherein the nominal rate is associated with a time that is between the availability window and another availability window.

13. The apparatus of claim 3, wherein the processing system is further configured to cause the apparatus to:
use a Maximum Time field to indicate the nominal rate.

14. The apparatus of claim 3, further comprising a transceiver configured to:
transmit the indication of the nominal rate to the wireless node, wherein the apparatus is configured as a wireless station.

15. An apparatus for wireless communication, comprising:
a processing system that includes one or more processors and one or more memories coupled with the one or more processors, the processing system configured to cause the apparatus to:
select an availability window having a duration for a ranging measurement operation and a nominal rate associated with the availability window, wherein the nominal rate is associated with one or more applications running on the apparatus;
perform one or more ranging measurements during the availability window; d
generate a location measurement report (LMR) including at least one of:
a result of the one or more ranging measurements, or
one or more updated parameters associated with the ranging measurement operation, wherein the one or more updated parameters comprise at least one of an updated nominal rate, an updated availability window duration, or an updated quantity of ranging measurements to be performed in the updated availability window; and
output, for transmission to a wireless node, the LMR.

16. The apparatus of claim 15, wherein:
the one or more updated parameters are based on an application need of the apparatus; and
the processing system is further configured to cause the apparatus to:
operate as at least one of an initiating station (ISTA) or a responding station (RSTA) for the ranging measurement operation; and
output the LMR regardless of whether the apparatus is configured to operate as the ISTA or the RSTA.

17. The apparatus of claim 15, wherein the processing system is further configured to cause the apparatus to:
adjust, during the ranging measurement operation, the nominal rate based on the one or more updated parameters.

18. The apparatus of claim 15, wherein the processing system is further configured to cause the apparatus to:
set a bit in a field of the LMR to indicate a need for updating one or more parameters.

19. The apparatus of claim 15, wherein:
the ranging measurement operation spans one or more availability windows; and
the processing system is further configured to apply the one or more updated parameters during the one or more availability windows.

20. The apparatus of claim 15, wherein the processing system is further configured to cause the apparatus to:
negotiate the one or more updated parameters with the wireless node in parallel with performing the one or more ranging measurements.
